(19) United States
(12) Patent Application Publication
(10) Pub. No.: US 2026/0241446 A1
(43) Pub. Date: Aug. 20, 2026

(54) HYBRID CERMET SINTERED BODY FOR A FRICTION STIR WELDING (FSW) TOOL

(71) Applicant: UNIVERSITY OF NORTH TEXAS, Dallas, TX (US)

(72) Inventors: Rajiv S. MISHRA, Dallas, TX (US); Supreeth GADDAM, Dallas, TX (US)

(21) Appl. No.: 19/180,992

(22) Filed: Apr. 16, 2025

Related U.S. Application Data
(60) Provisional application No. 63/690,530, filed on Sep. 4, 2024.

(51) Int. Cl. B22F 3/14; B22F 1/00; B22F 5/00; B22F 9/04; B23K 20/12; C22C 29/08

(52) U.S. Cl. CPC B22F 3/14; B22F 1/09; C22C 29/08; B22F 2005/002; B22F 2009/041; B22F 2202/00; B22F 2302/10; B23K 20/1245

(57) ABSTRACT

A method for coupling a tip to a shank for a friction stir welding (FSW) tool by mixing a high entropy alloy (HEA) powder and a tungsten carbide (WC) powder in a planetary ball mill to create a tip powder, forming one or more features at a distal end of the shank to facilitate coupling of the shank to the tip, positioning the shank and the tip powder in a stack to define a bond interface, and coupling the tip powder to the shank to form a body comprising the tip coupled with the shank for the friction stir welding (FSW) tool.

### CROSS-REFERENCE TO RELATED APPLICATIONS

This application claims benefit of U.S. Provisional Patent Application Ser. No. 63/690,530 filed Sep. 4, 2024, and entitled “HYBRID CERMET SINTERED BODY FOR A FRICTION STIR WELDING (FSW) TOOL,” the disclosure of which is hereby incorporated herein by reference in its entirety for all purposes.

### STATEMENT REGARDING FEDERALLY FUNDED RESEARCH OR DEVELOPMENT

This invention was made with government support under contract number 80NSSC20C0205 awarded by NASA and contract number N68335-19-C-0298 awarded by the Office of Naval Research. The government has certain rights in this invention.

### BACKGROUND

In a welding process of lightweight materials, a friction stir welding (FSW) technology, which is a non-melting solid state welding technology, is applied. Recently, the FSW technology spotlighted as a next generation technology is widely used in welding of similar and dissimilar materials of high melting point materials, such as titanium, steel, stainless and nickel alloys, as well as the lightweight materials, and also applied to various industrial fields.

### BRIEF DESCRIPTION OF THE DRAWINGS

For a detailed description of the aspects of the presently disclosed subject matter, reference will now be made to the accompanying drawings in which:

FIG. 1A depicts elemental powders for the HEA;

FIG. 1B depicts mechanically alloying the elemental powders, for example in a planetary ball mill;

FIG. 1C depicts the resulting mechanically alloyed HEA powder;

FIG. 2A depicts the HEA powder;

FIG. 2B depicts the WC powder;

FIG. 2C depicts mechanically alloying the HEA and WC powders, for example in a planetary ball mill;

FIG. 2D depicts the resulting mechanically alloyed WC-HEA tip powder;

FIG. 3A depicts exemplary shank blanks, according to embodiments of this disclosure;

FIG. 3B depicts a wire EDM setup for introducing features on the shank blank;

FIG. 3C depicts a shank, according to embodiments of this disclosure, with features on the distal end thereof;

FIG. 3D depicts another shank, according to embodiments of this disclosure, with features on the distal end thereof;

FIG. 4A depicts a spark plasma sintering (SPS) apparatus, according to embodiments of this disclosure;

FIG. 4B depicts an exemplary SPS setup for near-net shape FWS tool body manufacture, according to embodiments of this disclosure;

FIG. 5 is a representation of an extracted tool body removed from a (e.g., graphite) mold after SPS consolidation, according to embodiments of this disclosure;

FIG. 6A depicts a shank blank having features disposed on the distal end thereof, the cermet WC-HEA powder positioned adjacent thereto and the positioning of the punch and of the die and cap providing the mold to be subjected to pressure/sintering, according to embodiments of this disclosure;

FIG. 6B depicts the sintered, near-net shape FSW body comprising the shank and WC-HEA tip sintered together via sinter bond, according to embodiments of this disclosure;

FIG. 6C depicts a graphite mold blank that can be utilized to form the cap of the mold, and the shank blank, to which one or more features can be added, which mold and shank blank with one or more features can be utilized to make the near net-shape FSW body, according to embodiments of this disclosure;

FIG. 6D depicts an exemplary embodiment of the FSW tool body, according to embodiments of this disclosure.

FIG. 6E depicts an exemplary embodiment of the FSW tool body, according to embodiments of this disclosure;

FIG. 7A is a representation of an FSW tool comprising two-step spiral pin geometry;

FIG. 7B is a close up representation of two-step spiral pin geometry;

FIG. 8 is a graphical depiction of a process variable response for a first plunge cycle;

FIG. 9A, FIG. 9B, FIG. 9C, and FIG. 9D depict steps in preliminary friction stir welding plunge testing of the near-net-shape tool;

FIG. 10A, FIG. 10B, FIG. 10C, FIG. 10D, FIG. 10E, and FIG. 10F are representations of the results of preliminary friction stir welding plunge testing of the near-net-shape tool; and

FIG. 11 is a graphical depiction of room temperature hardness-fracture toughness comparison with other reported cermet materials in literature.

### DETAILED DESCRIPTION

Friction stir welding is a solid-state process whereby two or more workpieces can be joined together through heat and pressure generated by the engagement of a specially designed welding tool. In embodiments, a friction stir welding tool includes a tip or a pin that is inserted into the joint (of the two workpieces) and a shoulder that is applied against an upper surface of the workpieces. The pin and shoulder rotate while in contact with the workpieces to generate sufficient friction and heating to weld the work pieces to one another during operations. Similarly, friction stir processing can involve passing a friction stir welding tool through a single workpiece to modify the microstructure and/or the form of the workpiece without joining it to other workpieces.

Disclosed herein are embodiments related to the preparation method of a hybrid cermet sintered body for a FSW tool. The herein disclosed FSW tool can be utilized for FSW of high melting point materials, such as, and without limitation, ferrous, titanium-based, or nickel-based alloys. The hybrid cermet FSW tool can have a body comprising a tungsten carbide (WC) bonded with a high entropy alloy (HEA) binder (WC-HEA) tip that is sinter bonded to a shank. The shank can comprise a WC-cobalt (WC-Co), tungsten alloy (W-alloy), or pure tungsten (W) shank. The tip can comprise a cermet WC-HEA powder and the shank can comprise a cermented carbide. The body of the FSW tool is referred to as a “hybrid” because it includes two disparate materials (e.g., a WC-HEA tip and a tungsten-containing shank (e.g., a WC-Co, pure tungsten, or tungsten alloy shank) as opposed to a monolithic tool body material. The WC-HEA cermet tip with superior mechanical and chemical properties can enable superior performance in certain applications.

As used herein, a FSW cermet tool can be a type of cutting tool that is made of ceramic particles bonded together with a metallic binder, for example nickel or cobalt. Generally, cermet tools can have high wear resistance and ability to run at higher speeds than carbide tools, and can be used for finishing applications in stable conditions due to their high toughness. Typically, cermet tools are a type of composite material that combines the high-temperature performance and wear resistance of ceramics with the toughness, flexibility, or electrical conductivity of metals. Cermet tools can be utilized in a variety of applications, including without limitation, as cutting tools, wear-resistant parts, FSW tools, and other applications that require high strength, hardness, and toughness.

As used herein, the term “coupled” can mean two items, directly or indirectly, joined, fastened, associated, connected, or formed integrally together either by chemical or mechanical means, by processes including stamping, molding, sintering, sinter bonding, or welding. What is more, two items can be coupled by the use of a third component such as a mechanical fastener.

In embodiments, the disclosed tool can be used as a FSW tool that encompasses the use of a removable indexable cutting inserts. The indexable inserts can be mechanically fixed to the tool. The insert serves as a cutting tool in various configurations of material welding. Welding process parameters such as rotational rate, plunge depth and traverse speed allow the insert a means to both prepare the surface of the high melting point material for metallurgical bonding and manipulate the diffusion-controlled process of forming the intermetallic compound layer. Friction stir welding of high temperature alloys/materials are limited by availability of tool materials. Tools undergo severe wear and breakage due to combination of high temperature and forces. One tool material today is polycrystalline boron nitride (PCBN). These tools are difficult to manufacture and therefore quite expensive. Thus, there is a need for a near-net shape manufacturing of hybrid tools with new materials such as a WC based composition.

In embodiments, a preparation method can comprise the following steps: mechanically alloying elemental powders that make up the HEA, for example using a mixer such as a planetary ball mill, to provide a mechanically alloyed HEA powder; combining the mechanically alloyed HEA powder with an amount of WC powder and mechanically mixing the powder mixture (e.g., in a planetary ball mill or other mixer, etc.) to provide a WC-HEA powder; filling the WC-HEA powder in a mold (e.g., made of a heat resistant material such as a graphite material) and containing a shank; mounting the mold filled with WC-HEA powder in the chamber of a sintering apparatus (e.g., a spark plasma sintering apparatus, etc.); making a vacuum inside of the chamber and then refilling it with an inert gas, such as argon; molding the WC-HEA powder to provide the WC-HEA tip and create a sinter bond between the WC-HEA tip and the shank; and removing the sintered product from the (e.g., graphite) mold to provide the hybrid cermet body for the FSW tool. The molding can further comprise maintaining a constant pressure inside the mold and increasing the temperature according to a set heat increase pattern until the temperature reaches a target temperature; holding at the target temperature for a fixed time. The method can further include cooling the inside of the chamber while maintaining the pressure in the mold after the molding step. In embodiments, the shank comprises a cermented carbide. In embodiments, the shank comprises tungsten. In embodiments, the shank comprises pure tungsten, tungsten carbide, cobalt, or a combination thereof. In embodiments, the shank comprises tungsten carbide cobalt.

In embodiments, there is provided a preparation method of a FSW tool comprising a (e.g., tungsten carbide cobalt sintered body) shank coupled to a tungsten carbide high entropy alloy (WC-HEA) tip. The method can include filling tungsten carbide-high entropy alloy (WC-HEA) powder in (e.g., the tip region of) a mold (e.g., which mold can be made of a graphite material); installing the mold filled with the WC-HEA powder in a chamber of a sintering apparatus; providing a vacuum inside the chamber; and molding the WC-HEA powder in the mold. The WC-HEA powder can be molded while maintaining a constant pressure inside the mold and increasing a temperature according to a set heating pattern until the temperature reaches a target temperature; and cooling the inside of the chamber while maintaining the pressure applied in the mold after the molding.

A method for coupling a tip to a shank for a friction stir welding (FSW) tool, according to this disclosure, can comprise: mixing a high entropy alloy (HEA) powder and a tungsten carbide (WC) powder (e.g., in a planetary ball mill) to create a tip powder; forming one or more features at a distal end of the shank to facilitate coupling of the shank to the tip; positioning the shank and the tip powder in a stack to define a bond interface; and coupling the tip powder to the shank to form a body comprising the tip coupled with the shank for the friction stir welding (FSW) tool. The coupling can comprise any sintering such as a spark plasma sintering (SPS), as detailed further hereinbelow.

A HEA generally comprises an alloy formed by mixing a plurality of different metallic elements in relatively large proportions (e.g., equal proportions, etc.). For example, three or more elements, four or more elements, or five or more elements, or more can be mixed/combined to form the HEA. As disclosed herein, a WC-HEA can comprise tungsten carbide along with an alloy formed from one or more of aluminum, iron, chromium, cobalt, molybdenum, vanadium, tungsten, rhenium, and/or nickel. Thus, a method of this disclosure can include making the HEA powder by mechanically alloying one or more elemental powders. The one or more elemental powders comprise aluminum, iron, chromium, nickel, or a combination thereof. In embodiments, the one or more elemental powders comprise aluminum, iron, chromium, and nickel. In embodiments, one or more additional elements can also be present in the HEA. For example, the HEA can comprise vanadium (V), molybdenum (Mo), zirconium (Zr), yttrium (Y), hafnium (Hf), titanium (Ti), tantalum (Ta), niobium (Nb), manganese (Mn), silicon (Si), copper (Cu), or a combination thereof. In embodiments, exemplary HEA materials can include, but are not limited to, CrMnFeCoNi, CoCrFeMnNiAl_{1.3}, Al_{0.3}CoCrFeNi, CrCoCuFeNi, CoCrFeMnNiTi_{0.2}, CoCrFeMnNiTi_{0.8}, CoCrFeMnNiV_{0.07}, CoCrFeMnNiV_{1.1}, (CoCrFeMnNi)_{99.5}Mo_{0.5}, (CoCrFeMnNi)_{85.4}Mo_{14.6}, (CoCrFeMnNi)_{92.8}Nb_{7.2}, TiZrNbHfTa, FeCoNiCrCuAlMn, FeCoNiCrCuAl_{0.5}, AlCrMnMoNiZr, AlCrMoTaTiZr, AlCrTiTaZr, AlCrMoNbZr, AlCrNbSiTiV, AlCrSiTiZr, CrNbSiTaZr, CrNbSiTiZr, AlFeCrNiMo, CuMoTaWV, TiVCrZrHf, ZrTaNbTiW, TiVCrAlZr, FeCoNiCuVZrAl, or any other suitable HEA materials.

In embodiments, the WC-HEA tip powder comprises greater than or equal to about 80, 85, or 90 wt % tungsten carbide, and less than or equal to about 100, 99, or 98 wt % tungsten carbide, with the balance being the HEA powder. In embodiments, each of the elemental powders is present in the HEA in an amount within about 1-10 wt % of the elemental ratio of the elements making up the HEA powder (or of the elemental ratio making up a mixture of HEA powders). For example, a HEA powder for CrMnFeCoNi can comprise equal or substantially equal (e.g., without about 10 mol. %, without about 9 mol. %, within about 8 mol. %, within about 7 mol. %, within about 6 mol. %, within about 5 mol. %, within about 4 mol. %, within about 3 mol. %, within about 2 mol. %, within about 1 mol. %, within about 0.5 mol. %, within about 0.2 mol. %, or within about 0.1 mol. %) molar amounts of Cr, Mn, Fe, Co, and Ni.

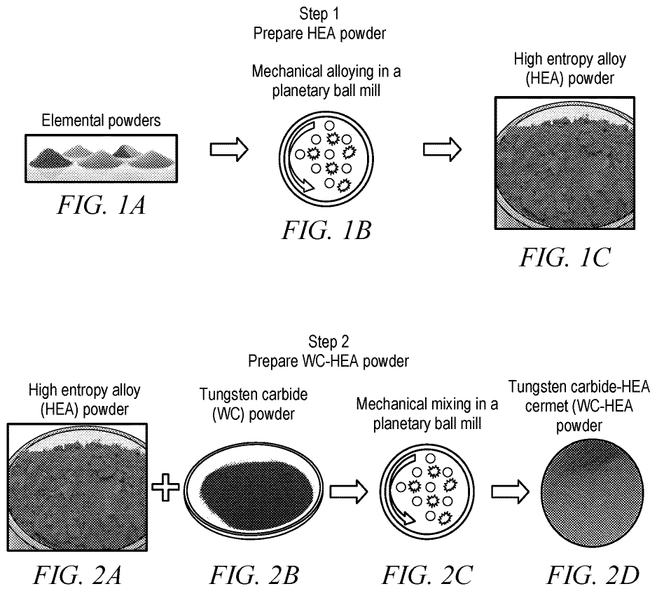

Description of the compositions and method of this disclosure will now be made with reference to FIGS. 1-5, which illustrate the steps that can be involved in the fabrication of near-net-shape hybrid cermet tools according to embodiments of this disclosure.

Prior to filling the WC-HEA powder in the mold, the process can comprise combining elemental powders of the HEA materials in the desired ratio, as shown in FIGS. 1A-1C, which are a schematic depiction and representations of a step of preparing an HEA powder. More specifically, FIG. 1A depicts the elemental powders; FIG. 1B illustrates mechanically alloying the elemental powders, for example in a planetary ball mill; and FIG. 1C depicts the resulting HEA powder. The powders (e.g., as illustrated in FIG. 1A) can thus be blended, for example using mechanical mixing, such as and without limitation, in a high-energy planetary ball mill (as depicted in FIG. 1B) until the powders are well blended. The resulting powder mixture can then form the HEA powder (as depicted in FIG. 1C). Any of the HEA compositions described herein can be used in the method as described in FIGS. 1A-1C.

Once provided, the HEA powder can be mixed with a tungsten carbide powder, for example, using mechanical mixing such as in a planetary ball mill, as shown in FIGS. 2A-2D, which are a schematic depiction and representations of a step of preparing an WC-HEA powder. The HEA powder (depicted in FIG. 2A) can be combined with the tungsten-carbide powder (depicted in FIG. 2B), and mechanically mixed, for example in a planetary ball mill (as depicted in FIG. 2C) to provide the WC-HEA powder (depicted in FIG. 2D). The resulting overall mixture can thus comprise the WC-HEA powder utilized to form the tip.

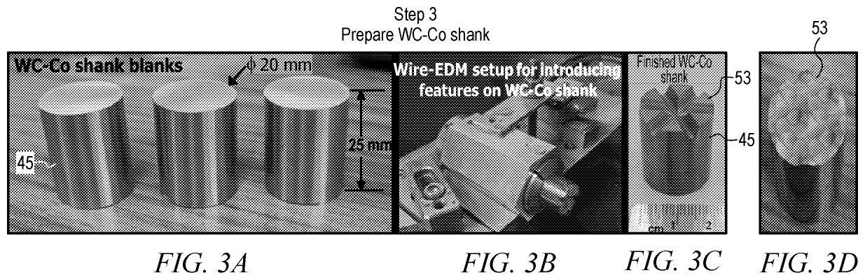

The WC-HEA powder can then be loaded into the mold. The process of setting up the mold can comprise preparing and inserting the shank in the mold so that the tip can be sinter bonded to the shank. As shown in FIGS. 3A-3D, which are representations of a step of preparing a shank; the shank can be prepared from a shank blank 45, such as the WC-Co shanks illustrated in FIG. 3A. In some aspects, one or more features can be formed on the end of the shank to improve the bonding between the shank and the tip. In some aspects, a cutting process such as wire electrical discharge machining (Wire EDM) can be used for form one or more features such as slots, grooves, castellations, or the like in the end of the shank, as depicted in FIG. 3B. Wire EDM can be a machining process that may use electrical sparks to erode material from a workpiece. Generally, Wire EDM may be an efficient method for shaping metal shanks, especially those made of hard materials like hardened steel, conductive carbides, and super alloys that are typically difficult to machine through traditional methods. In embodiments, Wire EDM can cut complex contours, slots, holes, and three-dimensional profiles often not feasible with conventional tools. The process can generate no cutting forces or vibration, allowing intricate features, thin walls, and fragile structures to be created. Generally, Wire EDM can easily cut hard, brittle, or delicate materials that may be difficult to machine with other methods. Components of a Wire EDM machine can include a power supply, a wire, a workpiece, and a dielectric fluid. Generally, the wire does not contact the workpiece, as any contact between the wire and the workpiece may result in a short circuit, preventing the cutting process from occurring. Usually, Wire EDM is utilized to machine electrically conductive materials, as the process uses electrical sparks to erode away material. FIG. 3C and FIG. 3D depict exemplary WC-Co shanks having one or more features on the distal end thereof, for sintering to the WC-HEA tip. In FIG. 3C, the distal end 53 comprises six channels radiating from a center of the distal end of the shank and forming a symmetric pattern at the distal end to lock the tip to the shank. In FIG. 3D, the distal end of the shank comprises a series of indentations to lock the tip to the shank. As will be apparent to those of skill in the art and with the help of this disclosure, numerous other features can be provided on the distal end of the shank for locking the tip thereto.

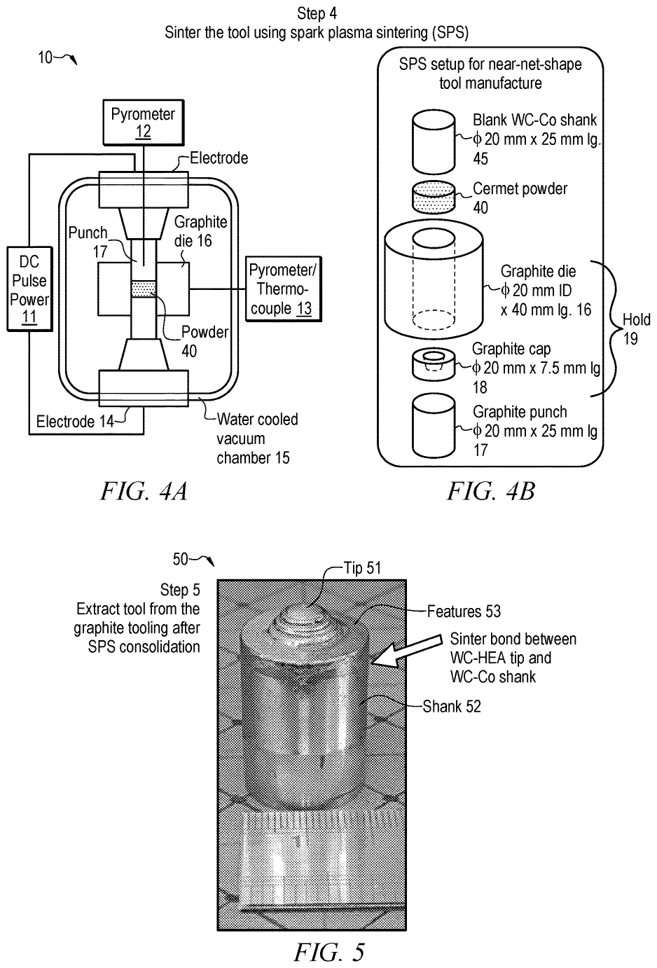

Once prepared, the shank and WC-HEA powder can be assembled in the mold as schematically represented in FIGS. 4A-4B, which are schematic depictions of a step of sintering a tool using spark plasma sintering (SPS). In this process, the shank can be loaded in the mold in contact with the WC-HEA powder so that during the molding process, the WC-HEA powder can form the tip while also being sintered to the shank. In some aspects, the FSW body for the FSW tool can be sintered using spark plasma sintering (SPS). A SPS apparatus can include any SPS apparatus known in the art, such as an SPS apparatus 10, such as depicted in FIGS. 4A-4B, comprising a DC pulse power 11, a pyrometer 12, a pyrometer/thermocouple 13, an electrode 14, a water cooled vacuum chamber 15, a graphite die 16, a (e.g., graphite) punch 17, and a (e.g., graphite) cap 18. The SPS setup for near-net shape FSW tool manufacture can be, as depicted in FIG. 4B, with cap 18 stacked above punch 17, die 16 stacked above die 16, and WC-HEA cermet powder 40 and shank 45 loaded into the mold 19 provided by the cap 18 and die 16. Once assembled, the mold 19 can be heated under a vacuum environment. The final target temperature of the molding can be any temperature sufficient to provide sintering, such as, for example and without limitation, in a range of from about 400° C. to about 3000° C., from about 1000° C. to about 2900° C., from about 1200° C. to about 2800° C., from about 1300° C. to about 2500° C., from about 1410° C. to about 2000° C., or from about 1600° C. to about 1800° C. In embodiments, the WC-HEA powder in the filling (e.g., filled into the mold) may have a particle size in a range of about 1 to about 1000 μm, from about 5 to about 500 μm, from about 10 to about 100 μm, or from about 25 to about 75 μm. The preparation method may further include preliminarily pressurizing the WC-HEA powder at a pressure of about 1400 to about 1600 kilogram-force (kg_{f}) and maintaining the pressure for about 5 to about 15 minutes, after the filling of the WC-HEA powder in the mold.

The molding may maintain the WC-HEA powder filled in the mold at a pressure in a range of from about 10 to about 1000 MPa, from about 20 to about 500 MPa, from about 30 to about 100 MPa, or from about 50 to about 80 MPa. The molding may include primarily heating the WC-HEA powder in the mold to a first target temperature at a heating rate of about 10 to about 150° C./min; maintaining the first target temperature for about 1 to about 60 minutes; secondarily heating the WC-HEA powder in the mold to a second target temperature at a heating rate of about 10 to about 150° C./min; maintaining the second target temperature for about 1 to about 60 minutes; thirdly heating the WC-HEA powder in the mold to a third target temperature at a heating rate of about 10 to about 150° C./min; maintaining the third target temperature for about 1 to about 60 minutes; fourthly heating the WC-HEA powder in the mold to a fourth target temperature at a heating rate of about 10 to about 150° C./min; maintaining the fourth target temperature for about 1 to about 60 minutes; fifthly heating the WC-HEA powder in the mold to a fifth target temperature at a heating rate of about 10 to about 150° C./min; maintaining the fifth target temperature for about 1 to about 60 minutes; sixthly heating the WC-HEA powder in the mold to a sixth target temperature at a heating rate of about 10 to about 150° C./min; maintaining the sixth target temperature for about 1 to about 60 minutes; seventhly heating the WC-HEA powder in the mold to a seventh target temperature at a heating rate of about 10 to about 150° C./min; and maintaining the seventh final target temperature for about 1 to about 60 minutes. The first target temperature may be about 550° C. to about 650° C., the second target temperature may be about 900° C. to about 1005° C., the third target temperature may be about 1010° C. to about 1105° C., the fourth target temperature may be about 1110° C. to about 1205° C., the fifth target temperature may be about 1210° C. to about 1305° C., the sixth target temperature may be about 1310° C. to about 1405° C., and the seventh target temperature may be about 1410° C. to about 2000° C. The molding may be carried out in two or more steps. Other heating programs and target temperatures will be apparent to those of skill in the art and with the help of this disclosure, and are within the scope of this disclosure. In embodiments, the WC-HEA sintered body can have a relative density of 99.5% or more.

In some embodiments of the preparation method of the tungsten carbide-HEA sintered body for the friction stir welding tool, it is possible to obtain a high relative density of 99.5% or higher, and also to prepare the uniform sintered body having a homogeneous structure with little particle growth, high toughness, high abrasion resistance and high strength within a short time by a single process via the use of pulsed current activation through a discharge plasma sintering apparatus, while having little difference between internal and external physical properties and a high thickness and large surface area.

Once the molding process is complete, the completed hybrid (e.g., comprising a shank and a tip of disparate materials) FSW tool can be removed from the mold. As depicted in FIG. 5, which is a representation of an extracted tool from a graphite mold after SPS consolidation, the resulting FSW tool body 50 can have the tip 51 sintered to the shank 52. As shown the tip 51 can comprise one or more features 53, such as and without limitation spiral grooves that can be defined by the mold.

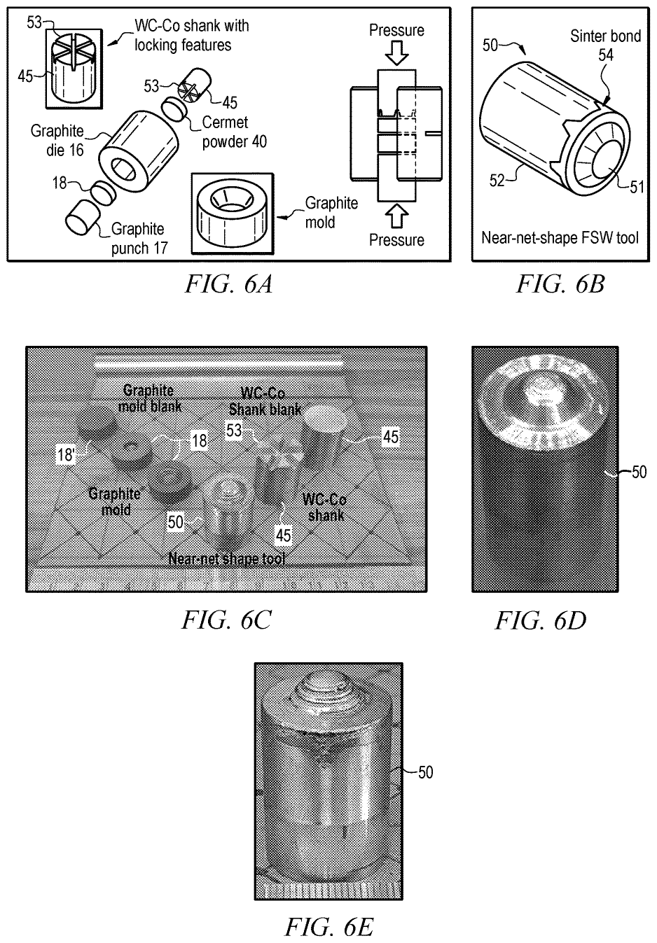

The tip 51 can be sintered to the shank 52 within the features 53 formed on the shank 52 to form a sintered and mechanical bond between the tip 51 and the shank 52. This is shown schematically in FIGS. 6A-6E, which are schematic depictions and representations of near-net-shape tool fabrication steps. FIG. 6A depicts a shank blank 45 having features 53 disposed on the distal end thereof (e.g., the end thereof proximal cermet powder 40 for the sintering), the cermet WC-HEA powder 40 positioned adjacent thereto and the positioning of the punch 17 and of the die 16 and the cap 18 providing the mold 19 to be subjected to pressure/sintering. FIG. 6B depicts the resulting, near-net shape FSW body 50 comprising the shank 52 and WC-HEA tip 51 sintered together via sinter bond 54. FIG. 6C depicts a graphite mold blank 18′ that can be utilized to form the cap 18 of the mold 19, and the shank blank 45, to which one or more features 53 can be added, which mold 19 and shank blank 45 with one or more features 53 can be utilized to make the near net-shape FSW body 50. FIG. 6D and FIG. 6E are exemplary embodiments of the FSW tool body 50.

Also provided herein is a friction stir welding (FSW) tool comprising: a hybrid cermet sintered body 50 produced as detailed herein and comprising: a shank 52; and a tip 51 coupled to a distal end of the shank 52, wherein the tip 51 comprises tungsten carbide and a high entropy alloy (HEA), as described hereinabove. In embodiments, the shank comprises tungsten carbide cobalt, tungsten alloy (W-alloy), or pure tungsten (W). In embodiments, the HEA comprises one or more selected from aluminum, iron, chromium, nickel, cobalt, molybdenum, vanadium, rhenium, or a combination thereof. For example, in embodiments, HEA comprises at least two of aluminum, iron, chromium, nickel, cobalt, molybdenum, vanadium, rhenium, or a combination thereof. In embodiments, the shank 52 is substantially cylindrical.

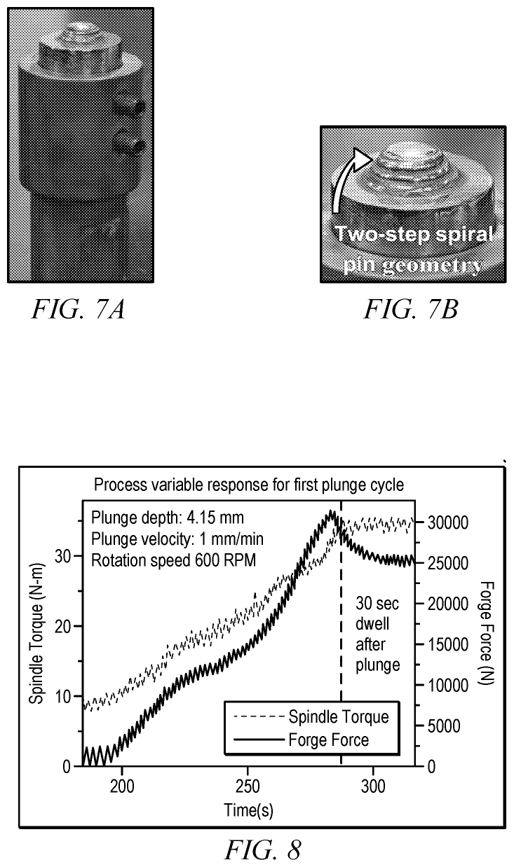

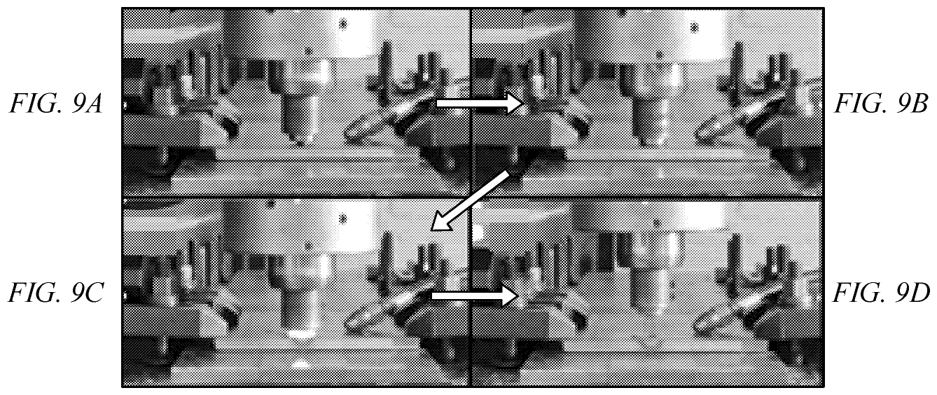

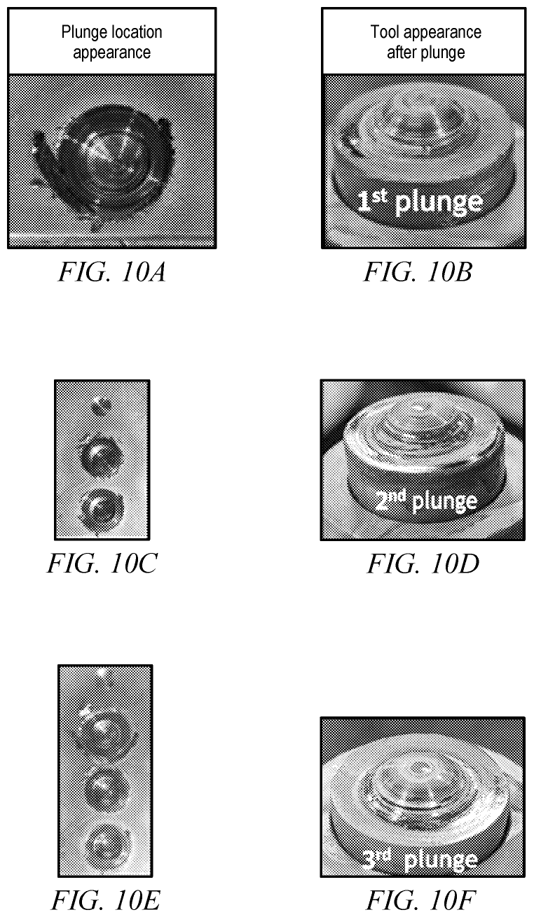

In use, the FSW insert/body 50 as disclosed herein can be mounted on a FSW tool and used to perform friction stir welding between two components. The completed tool and exemplary operating parameters, as well as preliminary friction stir welding plunge testing of the near-net-shape tool, are shown in FIGS. 7A-10F. FIGS. 7A-B are representations of two-step spiral pin geometry; FIG. 8 is a graphical depiction of a process variable response for a first plunge cycle. FIG. 9A, FIG. 9B, FIG. 9C, and FIG. 9D depict steps in preliminary friction stir welding plunge testing of the near-net-shape tool. FIG. 10A, FIG. 10B, FIG. 10C, FIG. 10D, FIG. 10E, and FIG. 10F are representations of the results of preliminary friction stir welding plunge testing of the near-net-shape tool: FIG. 10A, FIG. 10C, and FIG. 10E depict the plunge location appearance, while FIGS. 10B, 10D, and 10F show the respective tool appearance after the plunge.

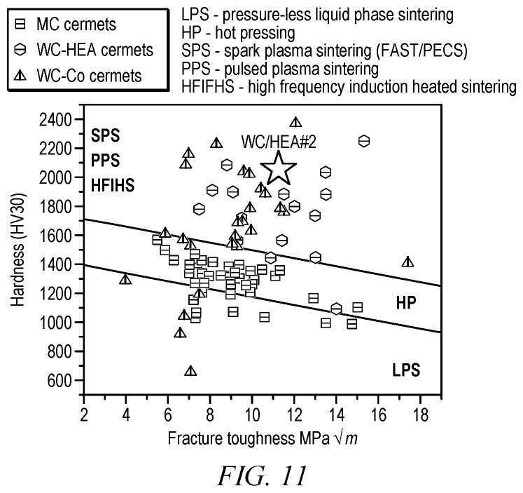

The disclosed tool and processes address technical problems related to friction stir welding. In particular, one problem is body fracture upon encountering higher strength materials. This is a result of large loads being imposed on the body during welding. During rotation and deformation of high strength materials, the body is a high stress concentration location. Body failure occurs when the strength of the body is exceeded, for example as a result of multi-directional loading during the plunging or traversing stages of the welding process. When the body fails, the tool is deemed useless, as the tool cannot penetrate to the intended depth or deform the high temperature material. In addition, the conventional method for manufacturing the current technology is difficult, and can be inconsistent. The tool and materials as disclosed herein can provide an improved hardness-fracture toughness profile to allow the tool to be used for FSW applications. Exemplary values compared to other materials and tools are shown in FIG. 11, which is a graphical depiction of room temperature hardness-fracture toughness comparison with other reported cermet materials in literature.

Design benefits of the tool and processes disclosed herein can include relatively more convenient manufacturing methods, and the ability to weld materials, where the second material has higher: hardness, and/or shear strength, and/or ultimate tensile strength. The benefits relative to prior tool bodies can include lower cost and commercial availability, at least in part due to the body being made from two different materials (e.g., a hybrid). In embodiments, the WC-HEA cermet tip provides superior mechanical and chemical properties, and thus, improved performance.

In embodiments, a method for manufacturing a friction stir welding tool for dissimilar welding encompasses: a pin, a shoulder, a component for mechanical fixation, and a tool manufactured for a material removal process. The tool body can contain a shoulder, pin, a cavity, a cutter and mechanical clamping.

In embodiments, in the manufacturing method, a tool body is comprised of a shaft that can be manufactured to have a shoulder and a pin and is made of a material such as steel, a steel alloy, tungsten, and/or an alloy which encompasses refractory metals. The tool body can have a cavity where material has been removed to allow for forming of a tip therein. Within the cavity, contact surfaces are placed to enable fixation to the tool body. The cavity surface contains angles, radii, or similar geometric features such as clearance angles, relief angles and nose radii, which conform to the geometry of the selected tool manufactured for a material removal process which aid in a secure fixation of the tip.

In embodiments, the tools described herein can be used in commercial friction stir welding applications, such as and without limitation, in the automotive, aerospace, aviation, shipbuilding, and other heavy manufacturing industries. An advantage of such use of the tools described herein can be a reduction in the cost of the production of components.

### Additional Disclosure

The following are non-limiting, specific embodiments in accordance with the present disclosure:

In a first embodiment, a method for coupling a tip to a shank for a friction stir welding (FSW) tool comprises: mixing a high entropy alloy (HEA) powder and a tungsten carbide (WC) powder in a planetary ball mill to create a tip powder; forming one or more features at a distal end of the shank to facilitate coupling of the shank to the tip; positioning the shank and the tip powder in a stack to define a bond interface; and coupling the tip powder to the shank to form a body comprising the tip coupled with the shank for the friction stir welding (FSW) tool.

A second embodiment can include the method of the first embodiment, wherein the HEA powder comprises one or more elemental powders selected from aluminum, iron, chromium, nickel, cobalt, molybdenum, vanadium, tungsten, rhenium, or a combination thereof.

A third embodiment can include the method of the first or second embodiment, wherein the HEA powder comprises one or more elemental powders selected from aluminum, iron, chromium, nickel, or a combination thereof, and is mixed with the WC powder to form the tip powder, wherein the tip powder comprises a cermet WC-HEA powder.

A fourth embodiment can include the method of any one of the first to third embodiments, wherein the shank comprises tungsten, a cermented carbide, or a combination thereof.

A fifth embodiment can include the method of the fourth embodiment, wherein the shank comprises pure tungsten, tungsten carbide, cobalt, or a combination thereof.

A sixth embodiment can include the method of the fifth embodiment, wherein the shank comprises tungsten carbide cobalt.

A seventh embodiment can include the method of any one of the first to sixth embodiments, wherein the coupling of the tip powder to the shank to form the body comprises sinter bonding.

An eighth embodiment can include the method of any one of the first to seventh embodiments further comprising making the HEA powder by mechanically alloying one or more elemental powders.

A ninth embodiment can include the method of the eighth embodiment, wherein the one or more elemental powders comprise aluminum, iron, chromium, nickel, or a combination thereof.

A tenth embodiment can include the method of the ninth embodiment, wherein the one or more elemental powders comprise aluminum, iron, chromium, and nickel.

An eleventh embodiment can include the method of any one of the first to tenth embodiments, wherein forming the one or more features at the distal end of the shank comprises machining.

A twelfth embodiment can include the method of the eleventh embodiment, wherein forming the one or more features at the distal end of the shank comprises wire electrical discharge machining (Wire EDM).

A thirteenth embodiment can include the method of any one of the first to twelfth embodiments, wherein positioning the shank and the tip powder in a stack to define the bond interface comprises positioning the shank and the tip powder in a mold.

A fourteenth embodiment can include the method of the twelfth embodiment, wherein the mold comprises a graphite mold.

A fifteenth embodiment can include the method of any one of the first to fourteenth embodiments, wherein the one or more features comprise one or more channels.

A sixteenth embodiment can include the method of the fifteenth embodiment, wherein the one or more channels form a symmetric pattern at the distal end to lock the tip to the shank.

In a seventeenth embodiment, a method for making a hybrid cermet sintered body for a friction stir welding (FSW) tool, wherein the hybrid cermet sintered body comprises a tungsten carbide (WC) bonded with a high entropy alloy (HEA) binder (WC-HEA) tip that is sinter bonded to a shank, comprises: mechanically alloying one or more elemental powders in a planetary ball mill to provide an HEA powder; combining the mechanically alloyed HEA powder with an amount of WC powder and mechanically mixing in a planetary ball mill to provide a WC-HEA powder; filling the WC-HEA powder in a mold containing the shank; mounting the mold filled with the WC-HEA powder in a chamber of a spark plasma sintering apparatus; creating a vacuum inside of the chamber and then refilling the chamber with inert argon gas; molding the WC-HEA powder and creating a sinter bond between the WC-HEA tip and the shank; and removing the sintered product from the graphite mold to reveal the hybrid cermet sintered body.

An eighteenth embodiment can include the method of the seventeenth embodiment, wherein molding further comprises: maintaining a substantially constant pressure inside the mold and increasing the temperature according to a set heat increase pattern until the temperature reaches a target temperature; and holding at the target temperature for a fixed time.

A nineteenth embodiment can include the method of the eighteenth embodiment further comprising cooling the inside of the chamber while maintaining the pressure in the mold after the molding.

A twentieth embodiment can include the method of any one of the seventeenth to nineteenth embodiments, wherein the shank comprises a tungsten carbide cobalt (WC-Co), tungsten alloy (W-alloy), or pure tungsten (W) shank.

In a twenty first embodiment, friction stir welding (FSW) tool comprises: a hybrid cermet sintered body comprising: a shank; and a tip coupled to a distal end of the shank, wherein the tip comprises tungsten carbide and a high entropy alloy (HEA).

A twenty second embodiment can include the FSW tool of the twenty first embodiment, wherein the shank comprises tungsten carbide cobalt, tungsten alloy (W-alloy), or pure tungsten (W).

A twenty third embodiment can include the FSW tool of the twenty first or twenty second embodiment, wherein the HEA comprises one or more selected from aluminum, iron, chromium, nickel, cobalt, molybdenum, vanadium, rhenium, or a combination thereof.

A twenty fourth embodiment can include the FSW tool of any one of the twenty first to twenty third embodiments, wherein the HEA comprises at least two of aluminum, iron, chromium, nickel, cobalt, molybdenum, vanadium, rhenium, or a combination thereof.

A twenty fifth embodiment can include the FSW tool of any one of the twenty first to twenty fourth embodiments, wherein the shank is substantially cylindrical.

While embodiments have been shown and described, modifications thereof can be made by one skilled in the art without departing from the spirit and teachings of this disclosure. The embodiments described herein are exemplary only, and are not intended to be limiting. Many variations and modifications of the embodiments disclosed herein are possible and are within the scope of this disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc. ; greater than 0.10 includes 0.11, 0.12, 0.13, etc.). For example, whenever a numerical range with a lower limit, Rl, and an upper limit, Ru, is disclosed, any number falling within the range is specifically disclosed. In particular, the following numbers within the range are specifically disclosed: R=Rl+k*(Ru−Rl), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. Use of broader terms such as comprises, includes, having, etc. should be understood to provide support for narrower terms such as consisting of, consisting essentially of, comprised substantially of, etc. When a feature is described as “optional,” both embodiments with this feature and embodiments without this feature are disclosed. Similarly, the present disclosure contemplates embodiments where this “optional” feature is required and embodiments where this feature is specifically excluded.

Accordingly, the scope of protection is not limited by the description set out above but is only limited by the claims which follow, that scope including all equivalents of the subject matter of the claims. Each and every claim is incorporated into the specification as embodiments of the present disclosure. Thus, the claims are a further description and are an addition to the embodiments of the present disclosure. The discussion of a reference herein is not an admission that it is prior art, especially any reference that can have a publication date after the priority date of this application. The disclosures of all patents, patent applications, and publications cited herein are hereby incorporated by reference, to the extent that they provide exemplary, procedural, or other details supplementary to those set forth herein.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A method for coupling a tip to a shank for a friction stir welding (FSW) tool, the method comprising:
mixing a high entropy alloy (HEA) powder and a tungsten carbide (WC) powder in a planetary ball mill to create a tip powder;
forming one or more features at a distal end of the shank to facilitate coupling of the shank to the tip;
positioning the shank and the tip powder in a stack to define a bond interface; and coupling the tip powder to the shank to form a body comprising the tip coupled with the shank for the friction stir welding (FSW) tool.

2. The method of claim 1, wherein the HEA powder comprises one or more elemental powders selected from aluminum, iron, chromium, nickel, cobalt, molybdenum, vanadium, tungsten, rhenium, or a combination thereof.

3. The method of claim 1, wherein the HEA powder comprises one or more elemental powders selected from aluminum, iron, chromium, nickel, or a combination thereof, and is mixed with the WC powder to form the tip powder, wherein the tip powder comprises a cermet WC-HEA powder.

4. The method of claim 1, wherein the shank comprises tungsten, a cermented carbide, or a combination thereof.

5. The method of claim 4, wherein the shank comprises pure tungsten, tungsten carbide, cobalt, or a combination thereof.

6. The method of claim 5, wherein the shank comprises tungsten carbide cobalt.

7. The method of claim 1, wherein the coupling of the tip powder to the shank to form the body comprises sinter bonding.

8. The method of claim 1, further comprising making the HEA powder by mechanically alloying one or more elemental powders.

9. The method of claim 8, wherein the one or more elemental powders comprise aluminum, iron, chromium, nickel, or a combination thereof.

10. The method of claim 9, wherein the one or more elemental powders comprise aluminum, iron, chromium, and nickel.

11. The method of claim 1, wherein positioning the shank and the tip powder in a stack to define the bond interface comprises positioning the shank and the tip powder in a mold.

12. A method for a hybrid cermet sintered body for a friction stir welding (FSW) tool, wherein the hybrid cermet sintered body comprises a tungsten carbide (WC) bonded with a high entropy alloy (HEA) binder (WC-HEA) tip that is sinter bonded to a shank, the method comprising:
mechanically alloying one or more elemental powders in a planetary ball mill to provide an HEA powder;
combining the mechanically alloyed HEA powder with an amount of WC powder and mechanically mixing in a planetary ball mill to provide a WC-HEA powder;
filling the WC-HEA powder in a mold containing the shank;
mounting the mold filled with the WC-HEA powder in a chamber of a spark plasma sintering apparatus;
creating a vacuum inside of the chamber and then refilling the chamber with inert argon gas;
molding the WC-HEA powder and creating a sinter bond between the WC-HEA tip and the shank; and
removing the sintered product from the graphite mold to reveal the hybrid cermet sintered body.

13. The method of claim 12, wherein molding further comprises:
maintaining a substantially constant pressure inside the mold and increasing the temperature according to a set heat increase pattern until the temperature reaches a target temperature; and
holding at the target temperature for a fixed time.

14. The method of claim 13 further comprising cooling the inside of the chamber while maintaining the pressure in the mold after the molding.

15. The method of claim 12, wherein the shank comprises a tungsten carbide cobalt (WC-Co), tungsten alloy (W-alloy), or pure tungsten (W) shank.

16. A friction stir welding (FSW) tool comprising:
a hybrid cermet sintered body comprising:
a shank; and
a tip coupled to a distal end of the shank, wherein the tip comprises tungsten carbide and a high entropy alloy (HEA).

17. The FSW tool of claim 16, wherein the shank comprises tungsten carbide cobalt, tungsten alloy (W-alloy), or pure tungsten (W).

18. The FSW tool of claim 16, wherein the HEA comprises one or more selected from aluminum, iron, chromium, nickel, cobalt, molybdenum, vanadium, rhenium, or a combination thereof.

19. The FSW tool of claim 16, wherein the HEA comprises at least two of aluminum, iron, chromium, nickel, cobalt, molybdenum, vanadium, rhenium, or a combination thereof.

20. The FSW tool of claim 16, wherein the shank is substantially cylindrical.
